(19) United States
(12) Patent Application Publication
(10) Pub. No.: US 2019/0334194 A1
(43) Pub. Date: Oct. 31, 2019

(54) FUEL CELL AND MANUFACTURING METHOD THEREFOR

(71) Applicant: TOYOTA JIDOSHA KABUSHIKI KAISHA, Toyota-shi (JP)

(72) Inventor: Katsumi SATO, Nissin-shi (JP)

(73) Assignee: TOYOTA JIDOSHA KABUSHIKI KAISHA, Toyota-shi (JP)

(21) Appl. No.: 16/364,441

(22) Filed: Mar. 26, 2019

(30) Foreign Application Priority Data
Apr. 25, 2018 (JP) 2018-084390

(51) Int. Cl. H01M 8/248

(52) U.S. Cl. CPC H01M 8/248

(57) ABSTRACT

A fuel cell capable of preventing a deterioration in power generation performance of a fuel cell stack is provided. A fuel cell includes a fuel cell stack, a first pressurizing plate disposed in one of sides of the fuel cell stack, a second pressurizing plate disposed on another side of the fuel cell stack, a third pressurizing plate disposed over the second pressurizing plate, an elastic sheet disposed between the second and third pressurizing plates in a compressed state, the elastic sheet being disposed so that a surface pressure applied to the fuel cell cells is maintained at or above a predetermined threshold when the fuel cell cells creep, and a restraining member adapted to restrain the fuel cell stack between the first and third pressurizing plates in a pressurized state. The elastic sheet includes a plurality of projections.

### CROSS REFERENCE TO RELATED APPLICATIONS

This application is based upon and claims the benefit of priority from Japanese patent application No. 2018-084390, filed on Apr. 25, 2018, the disclosure of which is incorporated herein in its entirety by reference.

### BACKGROUND

The present disclosure relates to a fuel cell and a manufacturing method therefor. For example, the present disclosure relates to a fuel cell in which a plurality of fuel cell cells are stacked and restrained in a pressurized state by a restraining member, and a method for manufacturing such fuel cell.

A typical fuel cell includes a fuel cell stack in which fuel cell cells like the one shown in FIG. 14 are stacked. In the fuel cell cell 100, an MEA (Membrane Electrode Assembly) sheet 108 is sandwiched between separators 109 and 110, The MEA sheet 108 includes: a catalyst layer 101, a microporous layer 102, and a gas diffusion layer 103 on a cathode electrode side; a catalyst layer 104, a microporous layer 105, and a gas diffusion layer 106 on an anode electrolyte side; and an electrolyte membrane 107 is sandwiched between the cathode electrolyte side and the anode electrolyte side.

When such fuel cell cells 100 are stacked on one another, they are fastened in a pressurized state by a fastening band so that air, hydrogen, or the like is not leaked from the stacked cells as disclosed in Japanese Unexamined Patent Application Publication No. 2005-142145.

### SUMMARY

The applicant of the present application has found the following problem. In a typical fuel cell, as the operating time of the fuel cell increases, an electrolyte membrane 107 deteriorates and its film thickness decreases. Further, each of catalyst layers 101 and 104, microporous layers 102 and 105, and gas diffusion layers 103 and 106 has a porous structure so that air and hydrogen permeate therethrough. Therefore, as the operating time of the fuel cell increases, they creep (i.e., deform with time) and their thicknesses decrease. Further, since loads (i.e., pressures) are concentrated on tops of corrugated separators 109 and 110, they also creep or/and deform. As a result, their thicknesses decrease.

Here, FIG. 15 shows a relation between loads that are applied to a fuel cell stack in order to pressurize the fuel cell stack and temperatures of the fuel cell stack. Further a load upper limit value and a load lower limit value indicate an upper limit value and a lower limit value of a range within which the fuel cell stack is satisfactorily pressurized.

Even in the case in which a fuel cell is formed by fastening a plurality of fuel cell stacks by a fastening band in advance so that fuel cell cells can be pressurized between a load upper limit value and a load lower limit value in an initial state even when the temperature of the fuel cell stacks changes as disclosed in Japanese Unexamined Patent Application Publication No. 2005-142145, as fuel cell cells creep with a lapse of time and hence a surface pressure acting on the fuel cell cells decreases, the load applied to the fuel cell stacks falls below the load lower limit value when the temperature of the fuel cell stacks is low, and hence the fuel cell stacks are not satisfactorily pressurized. As a result, contact resistances in fuel cell cells and contact resistances between adjacent fuel cell cells increase, thereby causing a problem that power generating performance of the fuel cell stacks deteriorates.

The present disclosure has been made in view of the above-described problem and an object thereof is to provide a fuel cell and a manufacturing method therefor capable of preventing or reducing a deterioration in power generation performance of a fuel cell stack.

A first exemplary aspect is a fuel cell in which a plurality of fuel cell cells are stacked and restrained in a pressurized state by a restraining member, including:

a fuel cell stack including a plurality of stacked fuel cell cells;

a first pressurizing plate disposed in one of sides of the fuel cell stack in a stacking direction of the fuel cell cells;

a second pressurizing plate disposed on another side of the fuel cell stack in the stacking direction of the fuel cell cells;

a third pressurizing plate disposed over the second pressurizing plate;

an elastic sheet disposed between the second and third pressurizing plates in a compressed state, the elastic sheet being disposed so that a surface pressure applied to the fuel cell cells is maintained at or above a predetermined threshold when the fuel cell cells creep; and

a restraining member adapted to restrain the fuel cell stack between the first and third pressurizing plates in a pressurized state, in which

the elastic sheet includes a plurality of projections.

As described above, the surface pressure applied to the fuel cell cells is maintained at or above the predetermined threshold by the elastic sheet. Therefore, even when the fuel cell cells creep (i.e., deform with time), it is possible to prevent power generation performance of the fuel cell stack from deteriorating.

In the above-described fuel cell, the elastic sheet preferably includes a plurality of elastic sheets piled on top of one another, the number of the plurality of elastic sheets being set based on an amount of the creep of the fuel cell cells that is estimated in advance so that the surface pressure applied to the fuel cell cells is maintained at or above the predetermined threshold.

In this way, it is possible to easily apply the above-described technique to various fuel cell stacks.

In the above-described fuel cell, the third pressurizing plate preferably includes a positioning pin protruding from a surface on a side of the third pressurizing plate opposite to a side thereof on which the second pressurizing plate is located.

Further, the restraining member preferably includes an insertion part into which the positioning pin is inserted.

In this way, it is possible to prevent a displacement (i.e., a positional deviation) of the restraining member with respect to the fuel cell stack and thereby to satisfactorily maintain the pressurized state of the fuel cell stack even when an external force is exerted on the fuel cell.

Another exemplary aspect is a method for manufacturing a fuel cell in which a plurality of fuel cell cells are stacked and restrained in a pressurized state by a restraining member, including:

forming a fuel cell stack by stacking the plurality of fuel cell cells, and pressurizing the fuel cell stack in a state where the fuel cell stack is interposed between a first pressurizing plate and a second pressurizing plate;

stacking a third pressurizing plate on the second pressurizing plate with an elastic sheet interposed therebetween in a state where the fuel cell stack is pressurized, the elastic sheet including a plurality of projections; and connecting the third pressurizing plate with the first pressurizing plate by a restraining member in the state where the fuel cell stack is pressurized, in which

the elastic sheet is compressed between the second and third pressurizing plates so that a surface pressure applied to the fuel cell cells is maintained at or above a predetermined threshold when the fuel cell cells creep.

As described above, the surface pressure applied to the fuel cell cells is maintained at or above the predetermined threshold by the elastic sheet. Therefore, even when the fuel cell cells creep, it is possible to prevent power generation performance of the fuel cell stack from deteriorating.

The above-described method for manufacturing a fuel cell preferably further includes setting the number of elastic sheets interposed between the second and third pressurizing plates based on an amount of the creep of the fuel cell cells that is estimated in advance so that the surface pressure applied to the fuel cell cells is maintained at or above the predetermined threshold.

In this way, it is possible to easily apply the above-described method to various fuel cell stacks.

In the above-described method for manufacturing a fuel cell, the pressurizing the fuel cell stack preferably includes hooking a pulling member on the second pressuring plate and pulling the fuel cell stack toward the first pressurizing plate.

The elastic sheet and the third pressurizing plate preferably include a cutout part, the cutout part being formed so that the elastic sheet and the third pressurizing plate do not interfere with the pulling member.

In this way, it is possible to remove the pulling member from the second pressurizing plate without interfering (i.e., colliding) with the elastic sheet and the third pressurizing plate.

According to the present disclosure, it is possible to provide a fuel cell and a manufacturing method therefor capable of preventing or reducing a deterioration in power generation performance of a fuel cell stack.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view schematically showing a fuel cell according to a first embodiment;

FIG. 2 is a plan view schematically showing the fuel cell according to the first embodiment;

FIG. 3 is a perspective view schematically showing an elastic sheet in the fuel cell according to the first embodiment;

FIG. 4A is a front view schematically showing a part of the elastic sheet in the fuel cell according to the first embodiment;

FIG. 4B is a plan view schematically showing a part of the elastic sheet in the fuel cell according to the first embodiment;

FIG. 5 is a perspective view schematically showing a first restraining member in the fuel cell according to the first embodiment;

FIG. 6 is a perspective view schematically showing a second restraining member in the fuel cell according to the first embodiment;

FIG. 7 is a front view showing a step of pressurizing a fuel cell stack in a method for manufacturing a fuel cell according to the first embodiment;

FIG. 8 is a front view showing a step of placing a third pressurizing plate over a second pressurizing plate with an elastic sheet interposed therebetween in the method for manufacturing the fuel cell according to the first embodiment;

FIG. 9 is a front view showing a step of restraining the fuel cell stack by a first restraining member in the method for manufacturing the fuel cell according to the first embodiment;

FIG. 10 is a plan view showing a state in which the fuel cell stack is restrained by the first restraining member in the method for manufacturing the fuel cell according to the first embodiment;

FIG. 11 shows a step of restraining the fuel cell stack by a second restraining member in the method for manufacturing the fuel cell according to the first embodiment;

FIG. 12 is a plan view schematically showing a fuel cell according to another embodiment;

FIG. 13 is a plan view schematically showing a different fuel cell according to another embodiment;

FIG. 14 is a cross section schematically showing a typical fuel cell; and

FIG. 15 shows a relation between loads that are applied to a fuel cell stack in order to pressurize the fuel cell stack and temperatures of the fuel cell stack,

### DESCRIPTION OF EMBODIMENTS

Specific embodiments to which the present disclosure is applied are described hereinafter in detail with reference to the drawings. However, the present disclosure is not limited to the below-shown embodiments. Further, the following description and drawings are simplified as appropriate for clarifying the explanation.

### First Embodiment

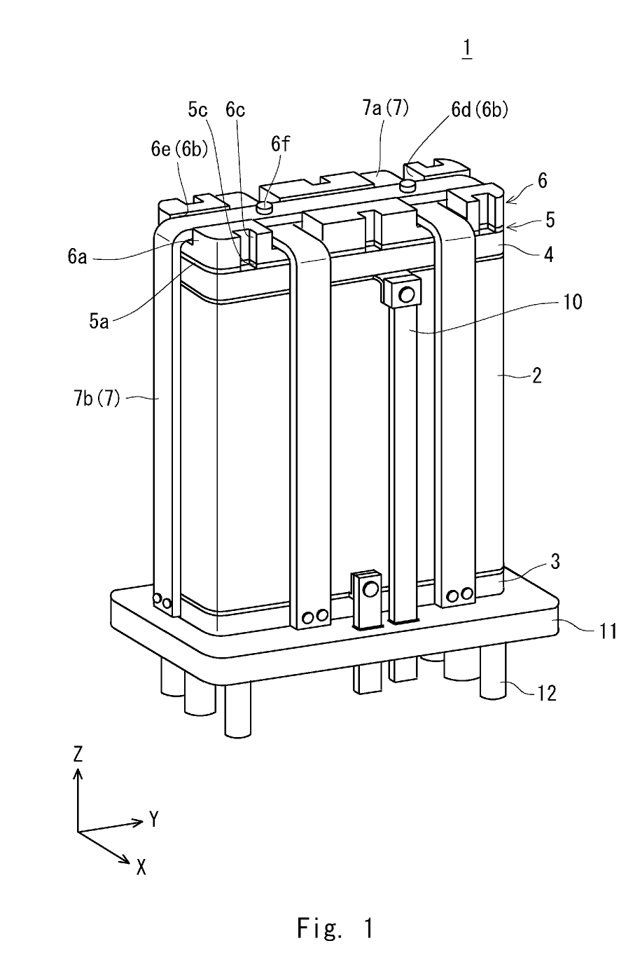

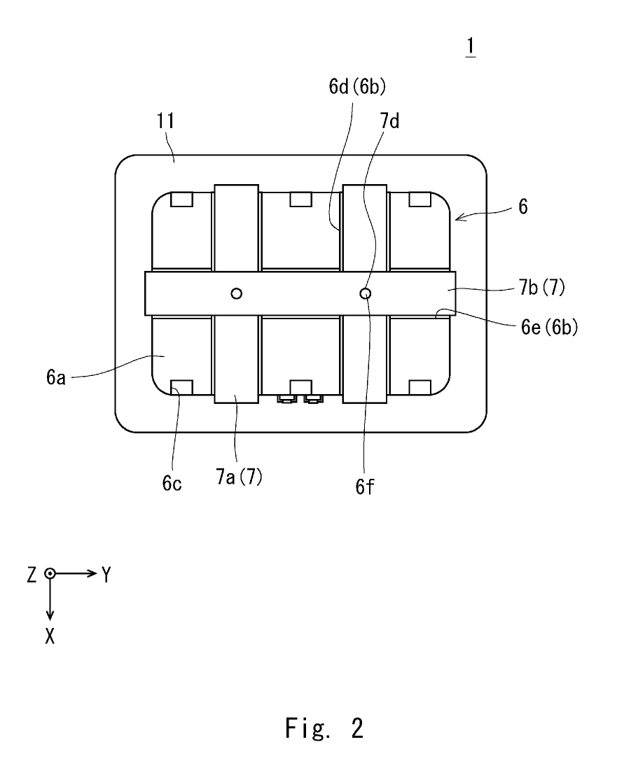

Firstly, a configuration of a fuel cell according to this embodiment is described. FIG. 1 is a perspective view schematically showing a fuel cell according to this embodiment, FIG. 2 is a plan view schematically showing the fuel cell according to this embodiment. Note that illustration of a fuel cell stack is simplified in FIG. 1. Note that the following descriptions are given by using a three-dimensional (XYZ) coordinate system for clarifying the descriptions.

As shown in FIG. 1, the fuel cell 1 includes a fuel cell stack 2, a first pressurizing plate 3, a second pressurizing plate 4, an elastic sheet 5, a third pressurizing plate 6, and restraining members 7. Further, the fuel cell 1 is housed in a housing (not shown)

In the fuel cell stack 2, fuel cell cells 100 like those described above in the Background section are stacked in the Z-axis direction with insulating films interposed therebetween. Further, the fuel cell cells 100 are pressurized so that a surface pressure equal to or higher than a predetermined threshold is applied to the fuel cell cells 100. Note that since the detailed configuration of the fuel cell cells 100 is not essential to the present disclosure, its explanation is omitted.

As viewed in the Z-axis direction, the fuel cell stack 2 has, for example, a roughly rectangular shape whose long sides are parallel to the Y-axis direction and whose short sides are parallel to the X-axis direction. However, the shape of the fuel cell stack 2 can be changed as appropriate according to the placement of the fuel cell 1 in a vehicle and the like.

Bus-bars 10 are electrically connected to the fuel cell stack 2. Specifically, one bus-bar 10 is electrically connected to the fuel cell stack 2 through a terminal plate disposed on the Z-axis positive side of the fuel cell stack 2 and extends in the Z-axis negative direction. Further, another bus-bar 10 is electrically connected to the fuel cell stack 2 through a terminal plate disposed on the Z-axis negative side of the fuel cell stack 2 and extends in the Z-axis negative direction. However, the placements and the extending directions of the bus-bars 10 can be changed as appropriate according to the placement of the fuel cell 1 in the vehicle and the like.

The first pressurizing plate 3 is disposed on the Z-axis negative side of the fuel cell stack 2. As viewed in the Z-axis direction, the first pressurizing plate 3 has an outer shape roughly identical to that of the fuel cell stack 2. For example, the first pressurizing plate 3 is a plate member having a roughly rectangular shape.

A stack manifold 11 is fixed to a surface on the Z-axis negative side of the first pressurizing plate 3. The stack manifold 11 supplies hydrogen and air necessary for power generation performed in the fuel cell stack 2 to the fuel cell stack 2 and also supplies coolant for cooling the fuel cell stack 2 to the fuel cell stack 2.

Pipes 12 for supplying hydrogen, air, and coolant to the stack manifold 11 is connected to the stack manifold 11. Further, the bus-bars 10 penetrate the stack manifold 11 in the Z-axis direction.

The second pressurizing plate 4 is disposed on the Z-axis positive side of the fuel cell stack 2. Further, the first and second pressurizing plates 3 and 4 sandwich the fuel cell stack 2 therebetween. As viewed in the Z-axis direction, the second pressurizing plate 4 has an outer shape roughly identical to that of the fuel cell stack 2. For example, the second pressurizing plate 4 is a plate member having a roughly rectangular shape.

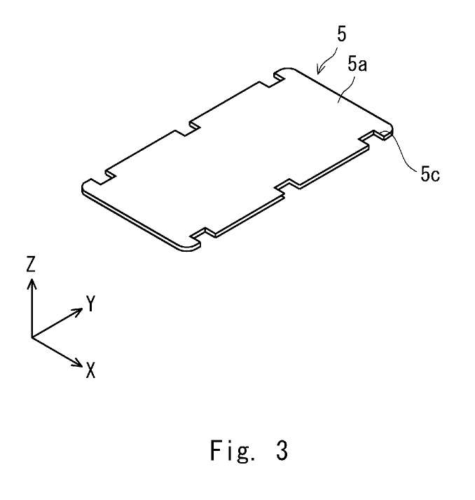

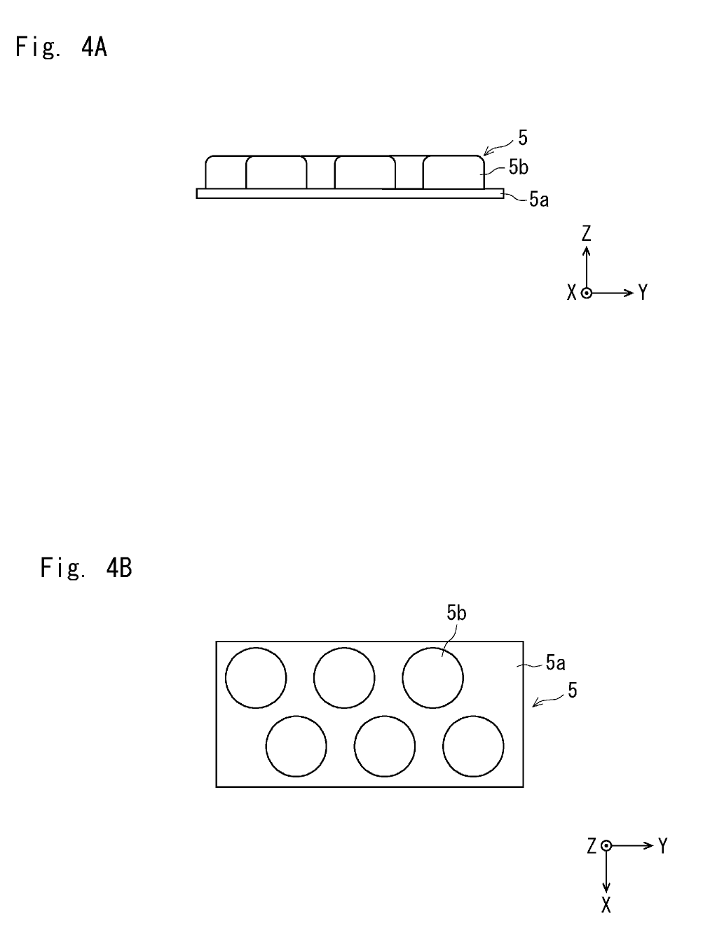

The elastic sheet 5 is disposed on the Z-axis positive side of the second pressurizing plate 4. FIG. 3 is a perspective view schematically showing an elastic sheet used in a fuel cell according to this embodiment. FIG. 4 schematically shows a part of the elastic sheet used in the fuel cell according to this embodiment. In particular, FIG. 4A is a front view of the elastic sheet and FIG. 4B is a plan view of the elastic sheet. Note that illustration of a main part of the elastic sheet is simplified in FIG. 3.

The elastic sheet 5 is made of an elastically deformable material such as an elastomer resin (e.g., silicone rubber). Further, as shown in FIGS. 3, 4A and 4B, the elastic sheet 5 includes a main part 5a, projections 5b, and cutout parts 5c. As viewed in the Z-axis direction, the main part 5a has an outer shape roughly identical to that of the second pressurizing plate 4. For example, the main part 5a is a sheet member having a roughly rectangular shape as its basic shape.

The projections 5b are formed on the main part 5a. Each of the projections 5b has, for example, a columnar shape and they are arranged in a regular pattern on a surface on the Z-axis positive side of the main part 5a as viewed in the Z-axis direction. However, the shape and the arrangement of the projections 5b can be changed as appropriate as described later. Further, each of the projections 5b may have a polygonal prism shape or a conical shape which can be elastically deformed as a load is concentrated. Further, they may he irregularly arranged.

The cutout parts 5c are formed in a plurality of places in the main part 5a. For example, three cutout parts 5c are arranged at roughly equal intervals on each of the long sides of the main part 5a opposed in the X-axis direction. Note that the arrangement of the cutout parts 5c can be changed as appropriate as described later.

The third pressurizing plate 6 is disposed on the Z-axis positive side of the elastic sheet 5. Further, in order to maintain the fuel cell stack 2 in a pressurized state, the first and third pressurizing plates 3 and 6 sandwich the fuel cell stack 2 therebetween with the elastic sheet 5 and the second pressurizing plate 4 being interposed between the third pressurizing plate 6 and the fuel cell stack 2. That is, the third pressurizing plate 6 is placed over the second pressurizing plate 4 with the elastic sheet 5 interposed therebetween.

The third pressurizing plate 6 includes a main part 6a, groove parts 6b, and cutout parts 6c. As viewed in the Z-axis direction, the main part 6a has an outer shape roughly identical to that of the second pressurizing plate 4. For example, the main part 6a is a sheet member having a roughly rectangular shape as its basic shape.

The groove parts 6b are formed on a surface on the Z-axis positive side of the main part 6a. In this embodiment, the groove parts 6b include first groove parts 6d and a second groove part 6e. The first groove parts 6d extend in the X-axis direction. Further, the first groove parts 6d are arranged in line symmetry with their symmetry axis being a straight line that passes through the center of the main part 6a and extends in the X-axis direction as viewed in the Z-axis direction.

The second groove part 6e extends in the Y-axis direction so as to traverse the first groove parts 6d, and is disposed roughly at the center in the X-axis direction. Note that the depth of the first groove parts 6d is deeper than the depth of the second groove part 6e. However, the configuration of the groove parts 6b can be changed as appropriate according to the number and the arrangement of restraining members 7 as described later.

The cutout parts 6c are formed in the main part 6a so as to correspond to the cutout parts 5c of the elastic sheet 5 as viewed from the Z-axis positive side Therefore, for example, three cutout parts 6c are arranged at roughly equal intervals on each of the long sides of the main part 6a opposed in the X-axis direction. Note that the arrangement of the cutout parts 6c can be changed as appropriate as described later.

The first, second and third pressurizing plates 3, 4 and 6 having the above-described configurations have such a material property that they are less likely to be deformed in a state where the fuel cell stack 2 is pressurized.

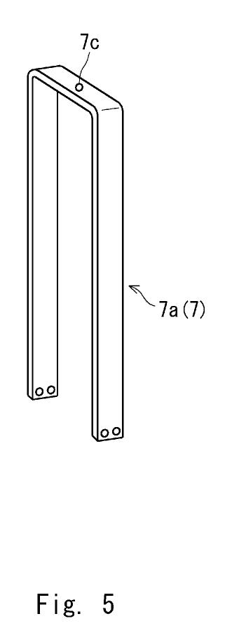

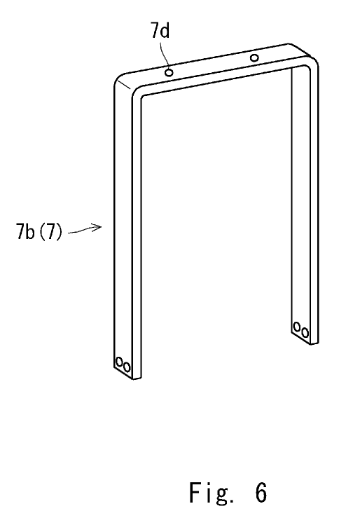

The restraining members 7 restrain the fuel cell stack 2 between the first and third pressurizing plates 3 and 6 in a pressurized state. In this embodiment, the restraining members 7 include, for example, first restraining members 7a and a second restraining member 7b. FIG. 5 is a perspective view schematically showing the first restraining member used in the fuel cell according to this embodiment. FIG. 6 is a perspective view schematically showing the second restraining member used in the fuel cell according to this embodiment.

As shown in FIGS. 1 and 5, the first restraining member 7a has an inverted U-shape and is disposed so as to straddle the third pressurizing plate 6 in the X-axis direction. Further, an end on the Z-axis negative side of the first restraining member 7a is connected to the first pressurizing plate 3 and a folding-back part (i.e., a bottom part of the inverted U-shape) on the Z-axis positive side of the first restraining member 7a is disposed inside the first groove part 6d of the third pressurizing plate 6.

As shown in FIGS. 1 and 6, the second restraining member 7b has an inverted U-shape and is disposed so as to straddle the third pressurizing plate 6 and the first restraining member 7a in the Y-axis direction. Further, an end on the Z-axis negative side of the second restraining member 7b is connected to the first pressurizing plate 3 and a folding-back part on the Z-axis positive side of the second restraining member 7b is disposed inside the second groove part 6e of the third pressurizing plate 6.

As described above, the first restraining members 7a are disposed inside the first groove parts 6d of the third pressurizing plate 6 and the second restriction member 7b is disposed inside the second groove part 6e of the third pressurizing plate 6. Therefore, it is possible to prevent a displacement (i.e., a positional deviation) of the first and second restraining members 7a and 7b with respect to the fuel cell stack 2 and thereby to satisfactorily maintain the pressurized state of the fuel cell stack 2 even when an external force is exerted on the fuel cell 1.

Note that in order to further prevent the displacement of the first and second restraining members 7a and 7b with respect to the fuel cell stack 2, the third pressurizing plate 6 preferably includes a positioning pin 6f.

The positioning pin 6f protrudes from a surface on the Z-axis positive side of the third pressurizing plate 6 and is disposed at the intersection of the first and second groove parts 6d and 6e. Meanwhile, the first and second restraining members 7a and 7b include insertion parts 7c and 7d, respectively, into which the positioning pin 6f is inserted. The insertion parts 7c and 7d may be, for example, through holes.

In this way, when the positioning pin 6f of the third pressurizing plate 6 is inserted into the insertion parts 7c and 7d of the first and second restraining members 7a and 7b, the displacement of the first and second and restraining member 7a and 7b with respect to the fuel cell stack 2 can be further prevented. However, the restraining member 7 may have any shape as long as it can restrain the fuel cell stack 2 between the first and third pressurizing plates 3 and 6 in the pressurized state. For example, the restraining member 7 may be a plate-like member or may have an inverted L-shape.

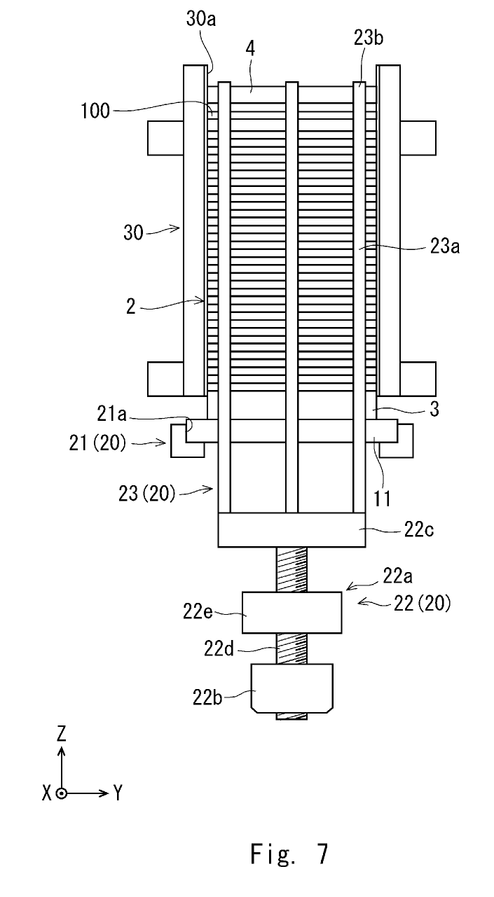

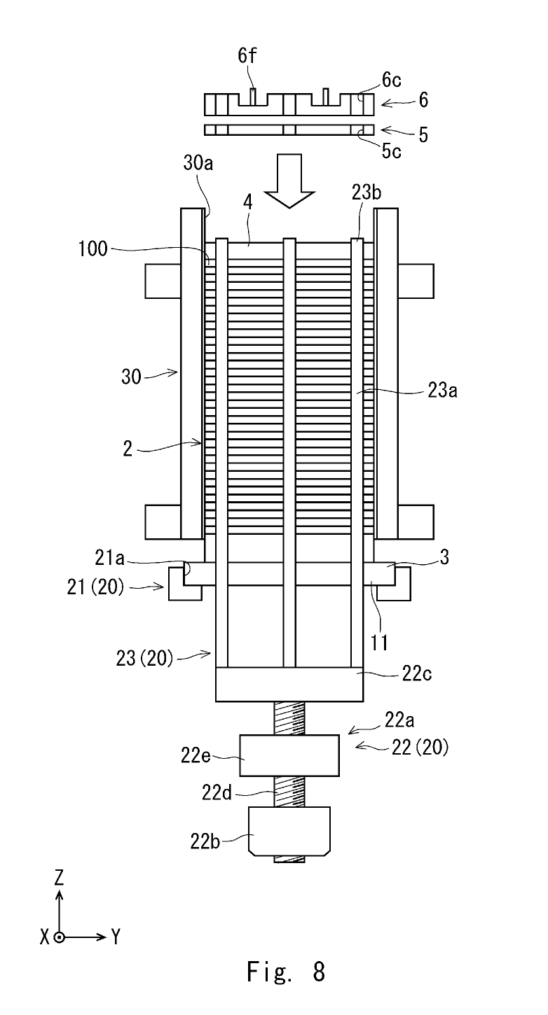

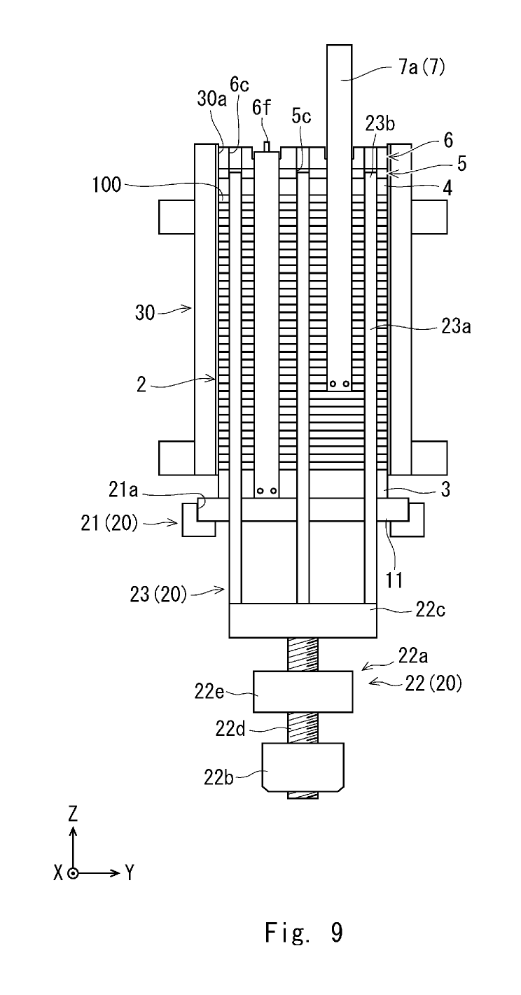

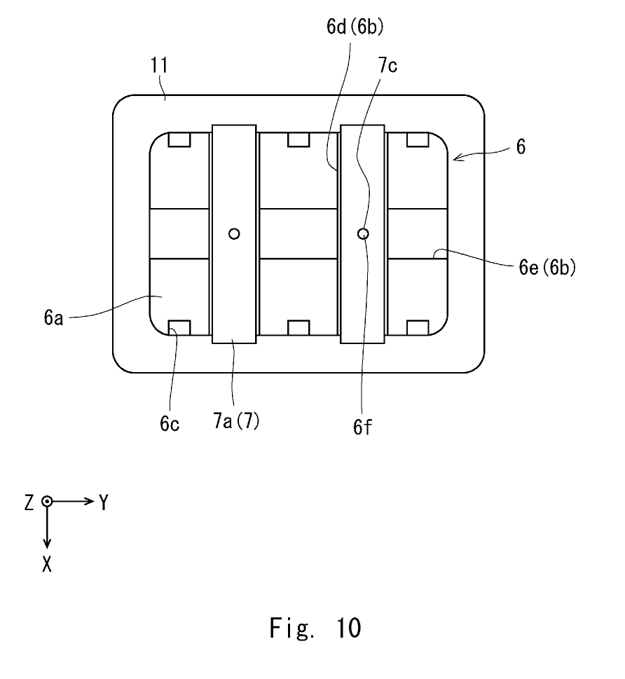

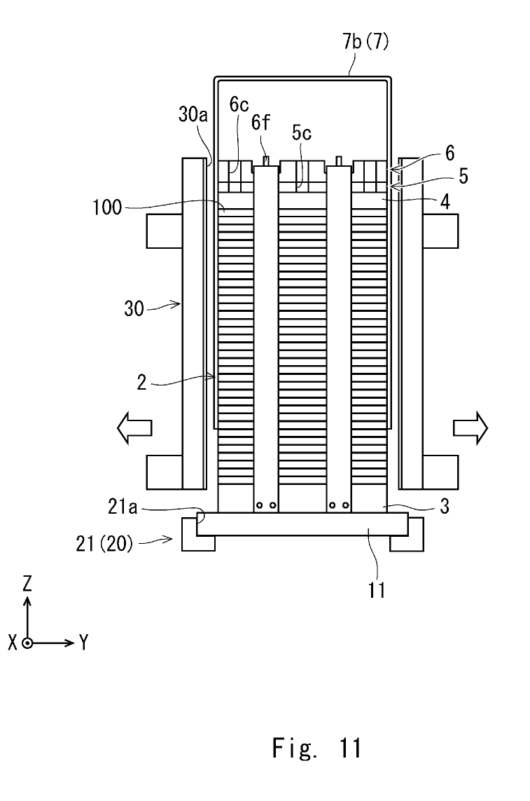

Next, a method for manufacturing a fuel cell 1 according to this embodiment is described. FIG. 7 is a front view showing a step of pressurizing a fuel cell stack in the method for manufacturing a fuel cell according to this embodiment. FIG. 8 is a front view showing a step of placing a third pressurizing plate over a second pressurizing plate with an elastic sheet interposed therebetween in the method for manufacturing the fuel cell according to this embodiment. FIG. 9 is a front view showing a step of restraining a fuel cell stack by a first restraining member in the method for manufacturing the fuel cell according to this embodiment. FIG. 10 is a plan view showing a state in which the fuel cell stack is restrained by the first restraining member in the method for manufacturing the fuel cell according to this embodiment. FIG. 11 shows a step of restraining the fuel cell stack by a second restraining member in the method for manufacturing the fuel cell according to this embodiment. Note that illustration of terminal plates is omitted In FIGS. 7, 8, 9 and 11.

Firstly, a configuration of a pressurizing apparatus 20 for pressurizing a fuel cell stack 2 is described hereinafter. As shown in FIG. 7 and the like, the pressurizing apparatus 20 includes a support part 21, a pulling mechanism 22, and a pulling member 23. Note that illustration of the pressurizing apparatus 20 is simplified in FIG. 7 and the like.

The support part 21 is fixed in a predetermined position in the Z-axis direction of the pressurizing apparatus 20 in order to support the stack manifold 11. For example, the support part 21 has, its base shape, an L-shape with a cutout part 21a in which an end of the stack manifold 11 in the Y-axis direction is disposed. Further, a plurality of support parts 21 are arranged with space therebetween in the Y-axis direction and extend in the X-axis direction. However, the support parts 21 may have any configuration as long as they can support the stack manifold 11.

The pulling mechanism 22 includes a ball screw 22a, a motor 22b, and a movable plate 22c. Further, the pulling mechanism 22 is disposed on the Z-axis negative side of the support part 21. The ball screw 22a includes a threaded rod 22d and a nut 22e.

The threaded rod 22d extends in the Z-axis direction. An end on the Z-axis negative side of the threaded rod 22d is connected to the motor 22b so that a driving force can be transmitted from the motor 22b to the threaded rod 22d. Further, an end on the Z-axis positive side of the threaded rod 22d is connected to the movable plate 22c in such a manner that the threaded rod 22d can rotate with respect to the movable plate 22c. The nut 22e is fixed at a predetermined position in the Z-axis direction in the pressurizing apparatus 20.

The movable plate 22c is, for example, a plate having a roughly rectangular shape in which the length of the movable plate 22c in the X-axis direction is longer than the length of the stack manifold 11 in the X-axis direction and shorter than the length of the first pressurizing plate 3 in the Y-axis direction.

As viewed in the Z-axis direction, the movable plate 22c is disposed so that both ends of the movable plate 22c in the X-axis direction protrude from the stack manifold 11 in a state in which the support part 21 supports the stack manifold 11. In the pulling mechanism 22 having the above-described configuration, when the motor 22b is driven, the movable plate 22c is moved in the Z-axis direction through the threaded rod 22d.

The pulling member 23 includes a vertical part 23a extending in the Z-axis direction and a hook part 23b extending in the X-axis direction. The hook part 23b extends from an end on the Z-axis positive side of the vertical part 23a. Further, the pulling member 23 has an inverted L-shape. Furthermore, a plurality of pairs each consisting of two pulling members 23 opposed to each other in the X-axis direction are arranged at roughly equal intervals in the Y-axis direction.

An end on the Z-axis negative side of the vertical part 23a is fixed to the movable plate 22c. The hooking part 23b is hooked on the second pressurizing plate 4 when the fuel cell stack 2 is pressurized by using the pressurizing apparatus 20. However, the configuration of the pressurizing apparatus 20 is not limited to the above-described configuration. That is, the pressurizing apparatus 20 may have any configuration as long as it can pressurize the fuel cell stack 2.

Firstly, as shown in FIG. 7, a stack manifold 11 fixed to a first pressurizing plate 3 is disposed in the cutout parts 21a of the support parts 21 of the pressurizing apparatus 20. Then, a fuel cell stack 2 is formed by stacking fuel cell cells 100 and insulating films on a surface on the Z-axis positive side of the first pressurizing plate 3 between stacking jigs 30 which are disposed so as to sandwich the first pressurizing plate 3 in the Y-axis direction. In this process, a terminal plate is disposed on each of the Z-axis negative and the Z-axis positive side of the fuel cell stack 2.

Further, a second pressurizing plate 4 is disposed on a surface on the Z-axis positive side of the fuel cell stack 2 (in particular, on a surface on the Z-axis positive side of the terminal plate located on the Z-axis positive side) between the stacking jigs 30. Each of the stacking jigs 30 has, for example, a reference surface 30a parallel to the XZ-plane. By stacking fuel cell cells 100 and insulating films by using the stacking jigs 30 as described above, the fuel cell cells 100 and the insulating films can be precisely stacked.

Next, the fuel cell stack 2 is pressurized by using the pressurizing apparatus 20 so that a surface pressure equal to or higher than a predetermined threshold is applied to the fuel cell cells 100. Specifically, the hooking parts 23b of the pulling members 23 of the pressurizing apparatus 20 are hooked on a surface on the Z-axis positive side of the second pressurizing plate 4. Then, by driving the motor 22b, the pulling member 23 is pulled toward the Z-axis negative side through the threaded rod 22d and the movable plate 22c.

As a result, the fuel cell stack 2 is compressed to the Z-axis negative side and thereby pressurized so that a surface pressure equal to or higher than the predetermined threshold is applied to the fuel cell cells 100. Note that the load that is applied to pressurize the fuel cell stack 2 can be set (i.e., determined) as appropriate according to the predetermined threshold. For example, the load is set to 50 kN.

Next, in the state where the fuel cell stack 2 is pressurized by the pressurizing apparatus 20, as shown in FIG. 8, a third pressurizing plate 6 is placed, between the stacking jigs 30, over a surface on the Z-axis positive side of the second pressurizing plate 4 with an elastic sheet 5 interposed therebetween.

In this process, the elastic sheet 5 and the third pressurizing plate 6 are disposed so that the hooking parts 23b of the pulling members 23 are disposed inside the cutout parts 5c of the elastic sheet 5 and the cutout parts 6c of the third pressurizing plate 6.

To that end, the places of the cutout parts 5c of the elastic sheet 5 and the cutout parts 6c of the third pressurizing plate 6 can be changed as appropriate according to the places of the hooking parts 23b of the pulling members 23 as described above.

Note that the height of the projections 5b of the elastic sheet 5 is preferably set (i.e., determined) so that they absorb an amount of creep of the fuel cell cells 100 that is estimated in advance (hereinafter also referred to as the pre-estimated amount of the creep).

Further, the thickness of the main part 5a of the elastic sheet 5, and the shape and the arrangement of the projections 5b are preferably set (i.e., determined) based on the pre-estimated amount of the creep of the fuel cell cells 100 so that the surface pressure applied to the fuel cell cells 100 is maintained at or above the predetermined threshold even when the fuel cell cells 100 creep. In this way, it is possible to adjust an elastic modulus of the elastic sheet 5.

Further, the number of elastic sheets 5 is preferably set (i.e., determined) based on the pre-estimated amount of the creep of the fuel cell cells 100 so that the surface pressure applied to the fuel cell cells 100 is maintained at or above the predetermined threshold even when the fuel cell cells 100 creep. In this way, it is possible to adjust an overall spring constant of a plurality of elastic sheets 5.

In short, the shape and the number of elastic sheets 5 may be set (i.e., determined) as appropriate based on the pre-estimated amount of the creep of the fuel cell cells 100 so that the surface pressure applied to the fuel cell cells 100 is maintained at or above the predetermined threshold even when the fuel cell cells 100 creep.

Next, as shown in FIG. 9, in the state in which the pressurization to the fuel cell stack 2 is maintained by the pressurizing apparatus 20, first restraining members 7a are disposed so as to straddle the third pressurizing plate 6 in the X-axis direction and folding parts of the first restraining members 7a are disposed inside the first groove parts 6d of the third pressurizing plate 6. Further, ends on the Z-axis negative side of the first restraining members 7a are fixed to the first pressurizing plate 3.

As a result, the fuel cell stack 2 is restrained in a pressurized state in which a surface pressure equal to or higher than the predetermined threshold is applied to the fuel cell cells 100. Then, the elastic sheet 5 is disposed between the second and third pressurizing plates 4 and 6 in a compressed state so that the surface pressure applied to the fuel cell cells 100 is maintained at or above the predetermined threshold when the fuel cell cells 100 creep.

Further, as shown in FIG. 10, positioning pins 6f of the third pressurizing plate 6 are inserted into insertion parts 7c of the first restraining members 7a. As a result, a displacement (i.e., a positional deviation) of the first restraining member 7a with respect to the fuel cell stack 2 is prevented by the first groove parts 6d and the positioning pins 6f of the third pressurizing plate 6.

Next, as shown in FIG. 11, in the state in which the pressurization to the fuel cell stack 2 is maintained by the first restraining members 7a, the hooking parts 23b of the pulling members 23 are released from the hooked state in which the hooking parts 23b are hooked on the third pressurizing plate 6. Note that illustration of a part of the pressurizing apparatus 20 is omitted in FIG. 11.

At this point, since the hooking parts 23b of the pulling members 23 are disposed inside the cutout parts 5c of the elastic sheet 5 and the cutout parts 6c of the third pressurizing plate 6, the hooking parts 23b can be removed from the surface on the Z-axis positive side of the second pressurizing plate 4 without interfering (i.e., colliding) with the elastic sheet 5 and the third pressurizing plate 6.

Then, the stacking jigs 30 are moved away from the fuel cell stack 2 and a second restraining member 7b is disposed so as to straddle the third pressurizing plate 6 in the Y-axis direction. Further, a folding part of the second restraining member 7b is disposed inside the second groove part 6e of the third pressurizing plate 6 and an end on the Z-axis negative side of the second restraining member 7b is fixed to the first pressurizing plate 3.

Further, as shown in FIG. 2, a positioning pin 6f of the third pressurizing plate 6 is inserted into an insertion part 7d of the second restraining member 7b. As a result, a displacement (i.e., a positional deviation) of the second restraining member 7b with respect to the fuel cell stack 2 is prevented by the second groove part 6e and the positioning pin 6f of the third pressurizing plate 6.

Then, a fuel cell 1 can be manufactured by electrically connecting bus-bars 10 to the fuel cell stack 2 with terminal plates interposed therebetween, enclosing the fuel cell stack 2 with housing, and connecting pipes 12 to the stack manifold 11.

In the above-described fuel cell 1 and the manufacturing method therefor, the elastic sheet 5 is disposed in a compressed state in advance. Therefore, when the fuel cell cells 100 creep, the elastic sheet 5 deforms so as to be restored (i.e., so as to expand). In this process, the fuel cell stack 2 is pushed toward the Z-axis negative side by the restoring force of the elastic sheet 5 and therefore the surface pressure applied to the fuel cell cells 100 is maintained at or above the predetermined threshold. Therefore, the fuel cell 1 and the manufacturing method therefor according to this embodiment can prevent power generation performance of the fuel cell stack 2 from deteriorating even when the fuel cell cells 100 creep.

In addition, it is possible to easily apply the above-described technique to various fuel cell stacks 2 by adjusting the shape, the number, etc. of elastic sheets 5 based on the amount of the creep of the fuel cell cells 100.

### Other Embodiments

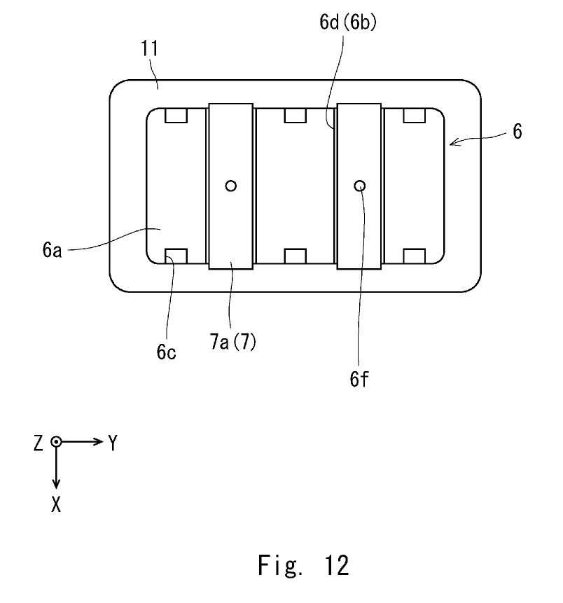

In the first embodiment, although the restraining member 7 includes the first and second restraining members 7a and 7b, the restraining member 7 is not limited to this example. For example, as shown in FIG. 12, in the case where a ratio of the length of the fuel cell stack 2 in the short-side direction to the length thereof in the long-side direction is large, the second restraining member 7b may be omitted and the fuel cell stack 2 may be pressurized only by the first restraining member(s) 7a.

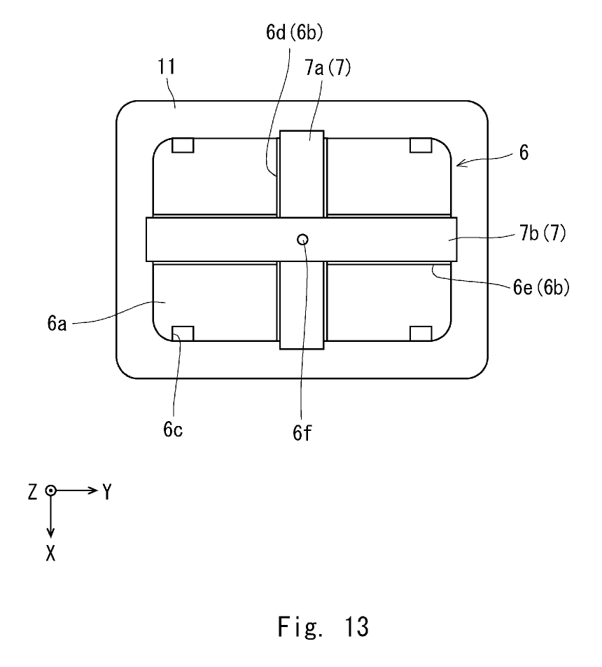

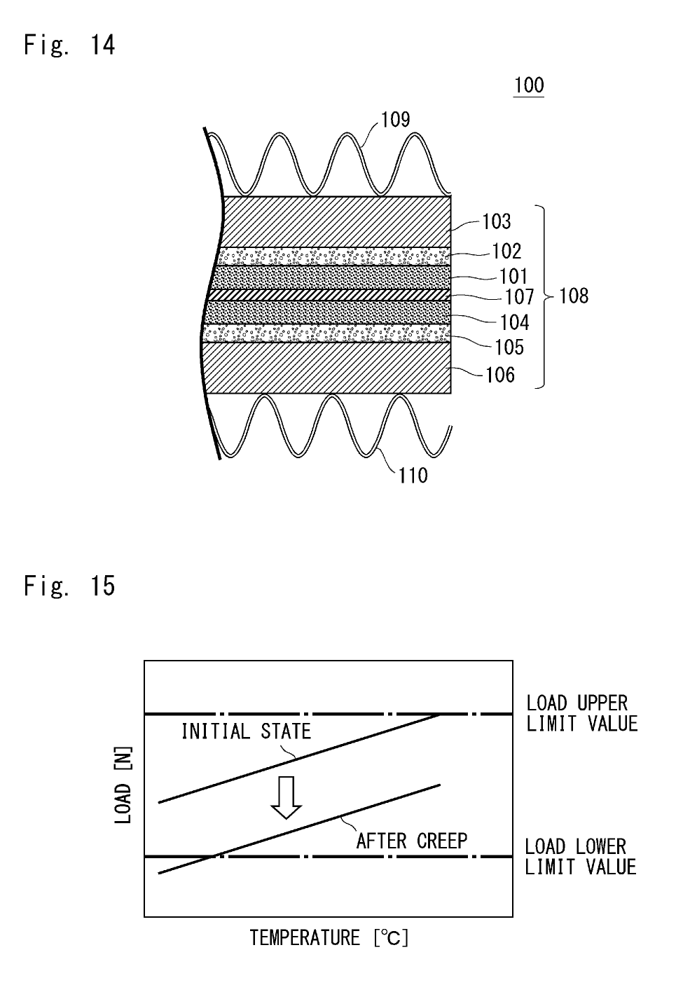

Further, as shown in FIG. 13, in the case where a difference between the length of the fuel cell stack 2 in the long-side direction and the length thereof in the short-side direction is small, the fuel cell stack 2 may be pressurized by using one first restraining member 7a and one second restraining member 7b. In short, the arrangement and the number of restraining members 7 can be changed as appropriate according to the shape of the fuel cell stack 2.

The present disclosure is not limited to the above-described embodiments and they can be modified as appropriate without departing from the scope and spirit of the present disclosure.

Although the third pressurizing plate 6 of the fuel cell 1 according to the above-described embodiments includes the groove parts 6b and the positioning pins 6f, the present disclosure can also be implemented without using these components.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A fuel cell in which a plurality of fuel cell cells are stacked and restrained in a pressurized state by a restraining member, comprising:
a fuel cell stack comprising a plurality of stacked fuel cell cells;
a first pressurizing plate disposed in one of sides of the fuel cell stack in a stacking direction of the fuel cell cells;
a second pressurizing plate disposed on another side of the fuel cell stack in the stacking direction of the fuel cell cells;
a third pressurizing plate disposed over the second pressurizing plate;
an elastic sheet disposed between the second and third pressurizing plates in a compressed state, the elastic sheet being disposed so that a surface pressure applied to the fuel cell cells is maintained at or above a predetermined threshold when the fuel cell cells creep; and
a restraining member adapted to restrain the fuel cell stack between the first and third pressurizing plates in a pressurized state, wherein
the elastic sheet comprises a plurality of projections.

2. The fuel cell according to claim 1, wherein the elastic sheet comprises a plurality of elastic sheets piled on top of one another, the number of the plurality of elastic sheets being set based on an amount of the creep of the fuel cell cells that is estimated in advance so that the surface pressure applied to the fuel cell cells is maintained at or above the predetermined threshold.

3. The fuel cell according to claim 1, wherein the third pressurizing plate comprises a positioning pin protruding from a surface on a side of the third pressurizing plate opposite to a side thereof on which the second pressurizing plate is located, and
the restraining member comprises an insertion part into which the positioning pin is inserted.

4. A method for manufacturing a fuel cell in which a plurality of fuel cell cells are stacked and restrained in a pressurized state by a restraining member, comprising:
forming a fuel cell stack by stacking the plurality of fuel cell cells, and pressurizing the fuel cell stack in a state where the fuel cell stack is interposed between a first pressurizing plate and a second pressurizing plate;
stacking a third pressurizing plate on the second pressurizing plate with an elastic sheet interposed therebetween in a state where the fuel cell stack is pressurized, the elastic sheet comprising a plurality of projections; and
connecting the third pressurizing plate with the first pressurizing plate by a restraining member in the state where the fuel cell stack is pressurized, wherein
the elastic sheet is compressed between the second and third pressurizing plates so that a surface pressure applied to the fuel cell cells is maintained at or above a predetermined threshold when the fuel cell cells creep.

5. The method for manufacturing a fuel cell according to claim 4, further comprising setting the number of elastic sheets interposed between the second and third pressurizing plates based on an amount of the creep of the fuel cell cells that is estimated in advance so that the surface pressure applied to the fuel cell cells is maintained at or above the predetermined threshold.

6. The method for manufacturing a fuel cell according to claim 4, wherein
the pressurizing the fuel cell stack comprises hooking a pulling member on the second pressuring plate and pulling the fuel cell stack toward the first pressurizing plate, and
the elastic sheet and the third pressurizing plate comprise a cutout part, the cutout part being formed so that the elastic sheet and the third pressurizing plate do not interfere with the pulling member.
